(19) United States
(12) Patent Application Publication
(10) Pub. No.: US 2014/0177953 A1
(43) Pub. Date: Jun. 26, 2014

(54) METHOD AND APPARATUS FOR EMBEDDING MESSAGE INTO IMAGE DATA

(71) Applicant: Samsung Electronics Co., Ltd., Suwon-si (KR)

(72) Inventor: Maksym SHEVCHENKO, Kiev (UA)

(73) Assignee: Samsung Electronics Co., Ltd., Suwon-si (KR)

(21) Appl. No.: 14/136,015

(22) Filed: Dec. 20, 2013

(30) Foreign Application Priority Data
Dec. 21, 2012 (KR) 10-2012-0151333

(51) Int. Cl. G06T 1/00; G06T 7/40; G06T 7/00; G06K 9/46

(52) U.S. Cl. CPC G06T 1/0021; G06K 9/4652; G06T 7/408; G06T 7/0083
USPC 382/164; 382/165

(57) ABSTRACT

A method of embedding and extracting a message into and from image data is provided. The method of embedding a message into image data includes: generating message data that is to be embedded into the image data; dividing the image data into a plurality of color channels, and embedding the message data into a difference component between two color channels of the plurality of color channels; reconstructing components of the two color channels by using original components of the two color channels and a difference component between the two color channels into which the message data is embedded; and reconstructing the image data by using the reconstructed components of the two color channels and an original component of a remaining color channel of the plurality of color channels.

### CROSS-REFERENCE TO RELATED PATENT APPLICATION

This application claims the benefit of Korean Patent Application No. 10-2012-0151333, filed on Dec. 21, 2012, in the Korean Intellectual Property Office, the disclosure of which is incorporated herein in its entirety by reference.

### BACKGROUND

1. Field

Methods and apparatuses consistent with exemplary embodiments relate to a method and apparatus for embedding a message into image data and a computer-readable recording medium storing executable instructions for performing the method.

2. Description of the Related Art

Images contents are provided using a personal computer (PC) or other various portable devices. As various image contents are provided, it is essential to prevent problems in regard to copyrights related to the image contents. Thus, data that is only known to an owner of a copyright has to be embedded in the image contents to an unrecognizable degree. With this hidden data, the owner of the copyright may prove ownership of corresponding data that is in question should a problem involving a copyright occur.

However, according to the conventional art, the size of data to be embedded is dependent upon complexity of an image, and the data is unable to be embedded into predetermined images.

### SUMMARY

Exemplary embodiments provide a method and apparatus for embedding a message by using a color channel included in image data and extracting the message from the image data into which the message is embedded.

According to an aspect of an exemplary embodiment, there is provided an image data processing method for embedding a message into image data, the method including: generating message data that is to be embedded into the image data; dividing the image data into a plurality of color channels resulting in a deconstruction of components of the image data, and embedding the message data into a difference component between a first color channel and a second color channel of the plurality of color channels; reconstructing components of the first color channel and the second color channel by using original components of the two color channels and the difference component between the first color channel and the second color channel into which the message data is embedded; and reconstructing the image data by using the reconstructed components of the two color channels and an original component of a remaining color channel of the plurality of color channels, wherein the above steps are performed by using a processor. The generating the message data may comprise combining a random sequence and the message to which a prefix is added.

The plurality of color channels may include a red channel, a green channel, and a blue channel.

The first color channel may be the red channel and the second color channel is the blue channel, and wherein the embedding the message data includes dividing the difference component between the first color channel and the second color channel into a plurality of sub-bands by performing fast wavelet transform (FWT) and embedding the message data into at least one from among the plurality of sub-bands of the divided difference component.

The remaining color channel of the plurality of color channels may include the green channel, and wherein the reconstructing the image data includes: detecting an edge component of the remaining color channel; blurring the detected edge component; and reconstructing the first color channel and the second color channel based on the difference component between the first color channel and the second color channel, the blurred edge component, a result of reverse fast wavelet transform (RFWT) performed on the image data into which the message data is embedded, and original components of the first color channel and the second color channel.

The reconstructing the first color channel and the second color channel may include reconstructing the first color channel and the second color channel by performing a calculation of one from among adding and subtracting a result of multiplication of a result of performing RFWT on the image data into which the message data is embedded, the blurred edge component of the remaining color channel, and intensities of signals to be embedded into the first color channel and the second color channel, to/from the original components of the first color channel and the second color channel.

The generating the message data may include adding a prefix to the message data, wherein the embedding the message data includes encoding the message data such that the message data to which the prefix is added is embedded into the difference component between the two color channels.

According to another aspect of an exemplary embodiment, there is provided an image data processing method of extracting a message data that is embedded into encoded image data, the method including: dividing the image data into a plurality of color channels and obtaining a difference component between a first color channel and a second color channel of the plurality of color channels; and extracting the message data embedded into the image data from the difference component between the first color channel and the second color channel, wherein the above steps are performed by using a processor.

The plurality of color channels may include a red channel, a green channel, and a blue channel.

The first color channel may be the red channel and the second color channel is the blue channel, wherein the extracting the message data includes: detecting an edge component of a remaining color channel of the plurality of color channels; blurring the detected edge component; and obtaining the message data into which the message is embedded based on the difference component between the first channel and the second channel and the blurred edge component.

The extracting the message may include obtaining the message data in which the message is embedded by performing a calculation of multiplying the difference component between the first channel and the second channel by an inverse of the blurred edge component.

The extracting of the message may include: dividing the data in which the message is embedded into sub-bands by performing fast wavelet transform (FWT); and extracting the message from the sub-bands.

The extracting the message may include: obtaining the encoded message data in which the message is embedded from the difference component between the first color channel and the second color channel; extracting the message by decoding the data into which the message is embedded; and synchronizing the extracted message with the image data.

According to another aspect of an exemplary embodiment, there is provided an image data processing apparatus including: a message generator configured to generate message data that is to be embedded into image data; a message embedder configured to divide the image data into a plurality of color channels resulting in a deconstruction of components of the image data and embed the message data into a difference component between a first color channel and a second color channel of the plurality of color channels; and an image reconstructor configured to reconstruct components of the first color channel and the second color channel by using original components of the two channels and the difference component between the two channels into which the message data is embedded, and reconstructing the image data by using reconstructed components of the two color channels and an original component of a remaining color channel of the plurality of color channels. The message generator may generate the message data by combining a random sequence and the message to which a prefix is added.

The plurality of color channels may include a red channel, a green channel, and a blue channel.

The first color channel may be the red channel and the second color channel is the blue channel, and the message embedder may include: a wavelet converter configured to perform fast wavelet transform (FWT) on the difference component between the first color channel and the second color channel, to divide the difference component into a plurality of sub-bands; and an encoder configured to embed the message data into at least one from among the plurality of sub-bands of the divided difference component.

The remaining color channel of the plurality of color channels may include the green channel, and wherein the image reconstructor detects an edge component of the remaining color channel, blurs the detected edge component, and performs reverse fast wavelet transform (RFWT) on the data into which the message data is embedded, wherein the first color channel and the second color channel are reconstructed based on the difference component between the first color channel and the second color channel, the edge component of the remaining color channel to which the blurring is performed, a result of RFWT on the image data into which the message data is embedded, and original components of the first color channel and the second color channel.

The image reconstructor may reconstruct the first color channel and the second color channel by performing a calculation of one from among adding and subtracting a result of multiplication of a result of performing RFWT on the image data into which the message data is embedded, the blurred edge component of the remaining color channel, and intensities of signals to be embedded into the first color channel and the second color channel, to/from the original components of the first color channel and the second color channel.

The message generator may add a prefix to the message data, and the message embedder may include an encoder that encodes the message such that the message data to which the prefix is added is embedded into a difference component between the two color channels.

According to another aspect of an exemplary embodiment, there is provided an image data processing apparatus including: an image processor configured to divide encoded image data into a plurality of color channels and obtain a difference component between a first color channel and a second color channel from among the plurality of color channels; and a message extractor configured to extract a message data that is embedded into the image data from the difference component between the first color channel and the second color channel.

The plurality of color channels may include a red channel, a green channel, and a blue channel.

The first color channel may be the red channel and the second color channel is the blue channel, wherein the message extractor detects an edge component of remaining channels of the plurality of color channels and blurs the detected edge component, and the message data into which a message is embedded is obtained based on the difference component between the first color channel and the second color channel and the blurred edge component.

The message extractor may obtain the message data into which the message is embedded, by performing a calculation of dividing the difference component between the first color channel and the second color channel by the blurred edge component.

The message extractor may include: a wavelet converter configured to perform fast wavelet transform (FWT) on the data into which the message is embedded, to thereby divide the data into a plurality of sub-bands; and a decoder configured to extract the message from the plurality of sub-bands.

The message extractor may obtain the encoded message data into which the message data is embedded, from the difference component between the first color channel and the second color channel, wherein the message extractor includes: a decoder configured to extract the message by decoding the encoded message data into which the message is embedded; and a synchronizer configured to synchronize the extracted message with the image data.

A non-transitory computer readable storage medium having embodied thereon a program, which when executed by a computer, performs any one of the above described methods.

### BRIEF DESCRIPTION OF THE DRAWINGS

The above and other features and advantages of exemplary embodiments will become more apparent with reference to the attached drawings in which:

FIG. 1 is a flowchart illustrating an operation of embedding a message into image data according to an exemplary embodiment;

FIG. 2 is a flowchart illustrating an operation of reconstructing components of two color channels according to an exemplary embodiment;

FIG. 3 is a schematic structural diagram of an image data processing apparatus for embedding a message into image data according to an embodiment of the present invention;

FIG. 4 is a detailed view of an operation of the image data processing apparatus for embedding a message into image data according to an exemplary embodiment;

FIG. 5 is a flowchart illustrating an operation of extracting a message from image data according to an exemplary embodiment;

FIG. 6 is a schematic structural diagram of an image data processing apparatus for extracting a message from image data according to an exemplary embodiment; and

FIG. 7 is a detailed view of an operation of the image data processing apparatus of extracting a message from image data according to an exemplary embodiment.

### DETAILED DESCRIPTION OF EXEMPLARY EMBODIMENTS

The attached drawings for illustrating exemplary embodiments are referred to in order to gain a sufficient understanding of the exemplary embodiments, the merits thereof, and the objectives accomplished by the implementation of the exemplary embodiments. Hereinafter, the exemplary embodiments will be described in detail with reference to the attached drawings. Like reference numerals in the drawings denote like elements. In the present specification, when a constituent element “connects” or is “connected” to another constituent element, the constituent element contacts or is connected to the other constituent element not only directly but also electrically through at least one of other constituent elements interposed therebetween. Also, when a part may “include” a certain constituent element, unless specified otherwise, it may not be construed to exclude another constituent element but may be construed to further include other constituent elements. Expressions such as “at least one of,” when preceding a list of elements, modify the entire list of elements and do not modify the individual elements of the list.

FIG. 1 is a flowchart illustrating an operation of embedding a message into image data according to an exemplary embodiment.

First, in operation S100, an image data processing apparatus may generate message data that is to be embedded into image data.

Here, message refers to information that is to be embedded into image data. For example, the message may be information in the form of an image or a text. The message data contains a message to be embedded into image data, and refers to data that is obtained by performing image processing on a message.

According to an exemplary embodiment, the image data processing apparatus may encode message data of 4 to 5 bits and may add a prefix to the message data. The image data processing apparatus may embed a bit for forward error correction into the encoded message data.

Also, according to another exemplary embodiment, the image data processing apparatus may generate a pseudo random sequence based on a previously set code key. The image data processing apparatus may combine the pseudo random sequence that is generated for coding and a message data that is to be encoded.

Next, in operation S110, the image data processing apparatus may divide image data into a plurality of color channels, and embed the encoded message data generated in operation S100 into a difference component between two of the plurality of color channels (hereinafter, a color channel will be referred to as a channel). A difference component may comprise difference values of two of the plurality of color channels.

According to an exemplary embodiment, the image data processing apparatus may divide the difference component of two color channels into sub-bands. Here, the image data processing apparatus may generate data including the message data generated in operation S100 in at least one of the divided sub-bands. Also, the image processing apparatus may perform, for example, fast wavelet transform (FWT) on the difference component of the two color channels to thereby divide the difference component between the two channels into sub-bands. FWT is a conversion method applied in voice signal processing or image signal processing, and conversion between a time region and a frequency region is performed in FWT.

According to an exemplary embodiment, the plurality of color channels may include a red channel, a green channel, and a blue channel. Here, for example, a difference component between the red channel and the blue channel may be considered a difference component between two color channels.

Next, in operation S120, the image data processing apparatus may reconstruct components of the two color channels by using the difference component of those two color channels into which a message is embedded and original components of the two color channels.

In the reconstructed components of the two color channels, information about the message data, into a difference component between the two color channels of which a message is embedded, has to be included.

According to an exemplary embodiment, after performing FWT, the image data processing apparatus may perform reverse fast wavelet transform (RFWT) on the image data in which a message is inserted into its at least one sub-band. The image data processing apparatus may then reconstruct components of the two color channels based on a result of RFWT.

Next, the image data processing apparatus may reconstruct image data by using the reconstructed components of the two color channels of operation S120 and an original component of the remaining the color channel.

For example, when image data is divided into a red channel, a green channel, and a blue channel in operation S110, image data may be reconstructed by using reconstructed components of the red channel and the blue channel of operation S120 and an original component of the green channel.

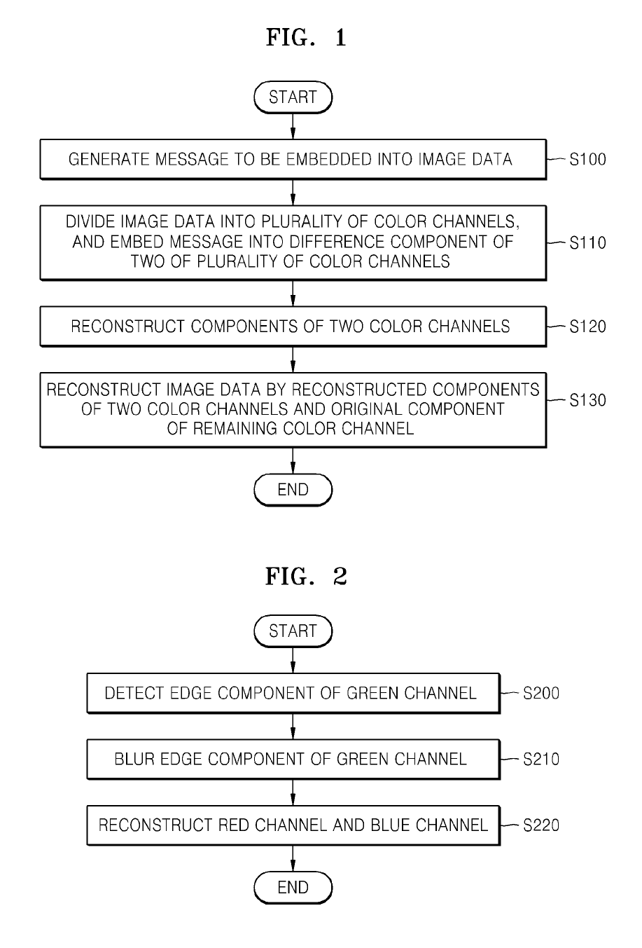

FIG. 2 is a flowchart illustrating an operation of reconstructing components of two color channels according to an exemplary embodiment.

In detail, the flowchart of FIG. 2 illustrates operation S120 of reconstructing components of two color channels after image data has been divided into a red channel, a green channel, and a blue channel in operation S110.

First, the image data processing apparatus detects an edge component of the green channel in operation S200. Here, the image data processing apparatus may detect an edge component in various manners. For example, the image data processing apparatus may apply the Sobel Operator to detect an edge component.

Next, in operation S210, the image data processing apparatus blurs the edge component of the green channel. Blurring may be an operation for applying a filter, such as a normalized Gaussian filter.

According to an exemplary embodiment, for data normalization, a normalized Gaussian Blur may be applied.

Next, in operation S220, the image data processing apparatus may reconstruct the red channel and the blue channel.

According to an exemplary embodiment, the image data processing apparatus may reconstruct the red channel and the blue channel based on the difference component between the red channel and the blue channel, the blurred edge component of the green channel, the result of RFWT with respect to message data, the message data having a message embedded, and original components of the red channel and the blue channel.

Also, according to an exemplary embodiment, the image data processing apparatus may reconstruct the red channel and the blue channel according to Equation 1 below.

R_{new}=R_{orig}+(W_{data}−RB_{diff})×E_{blur}×α_{red}

B_{new}=B_{orig}−(W_{data}−RB_{diff})×E_{blur}×α_{blue}, [Equation 1]

where R_new denotes a component of a reconstructed red channel. B_new denotes a component of a reconstructed blue channel. R_orig denotes an original component of a red channel. B_orig denotes an original component of a blue channel. W_data denotes a result of RFWT with respect to a difference component of the red channel and the blue channel into which message data is embedded. RB_diff denotes the difference component of the red channel and the blue channel. E_blur denotes a result of blurring an edge component of the green channel. α_red and α_blue denote intensities of signals to be embedded into the red channel and the blue channel, respectively. α_red and α_blue have a relationship as expressed in Equation 2 below.

α_{red}+α_{blue}=1, [Equation 2]

where when normalized blurring is applied to the edge component of the green channel, R_new and B_new may be normalized in a range of 0 to 255.

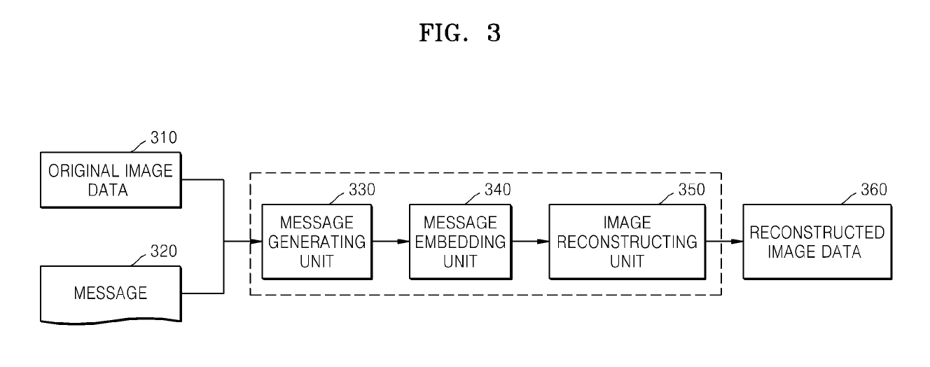

FIG. 3 is a schematic structural diagram of an image data processing apparatus 300 for embedding a message into image data according to an exemplary embodiment.

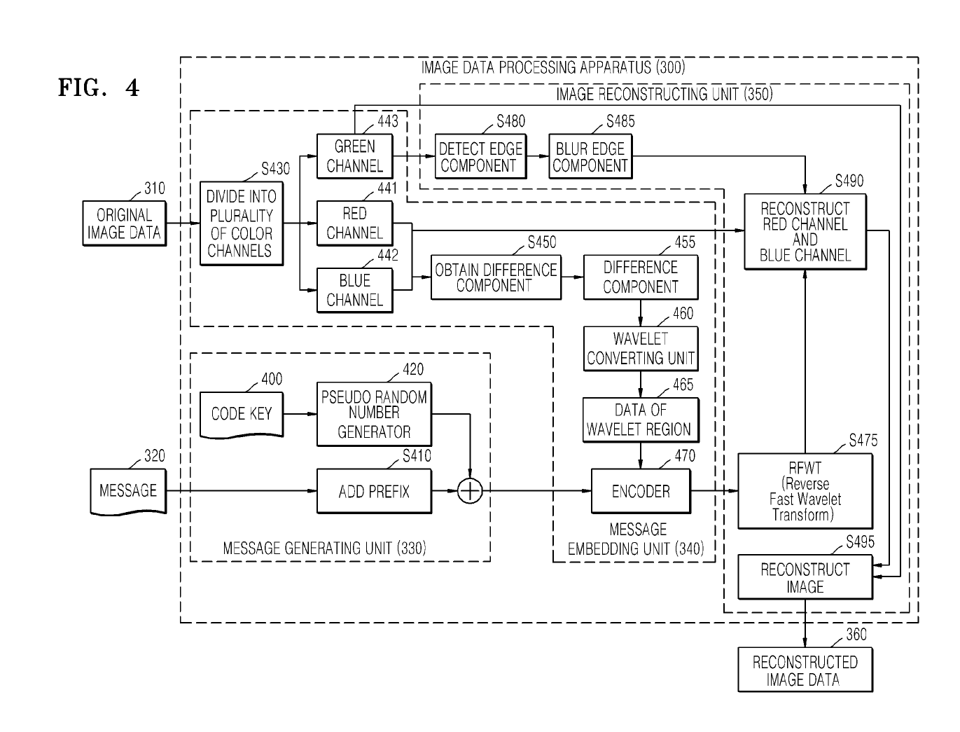

The image data processing apparatus 300 may include a message generating unit 330 generating encoded message data based on a message 320 that is to be embedded into original image data 310, a message embedding unit 340 that divides the original image data 310 into a plurality of color channels and embeds the generated message data into a difference component between two of the plurality of color channels, and an image reconstructing unit 350 that reconstructs an image data. While not shown in FIG. 4, the image data processing apparatus 300 may include a processor for device control and calculation.

The image data processing apparatus 300 may generate reconstructed image data 360 that message 320 is embedded into the original image data 310.

FIG. 4 is a detailed view of an operation of the image data processing apparatus 300 for embedding a message data into image data according to an exemplary embodiment.

The message generating unit 330 of the image data processing apparatus 300 may convert the message data including the message 320 of 4 bits to 5 bits and add a prefix to the message 320 in operation S410.

Also, the message generating unit 330 may generate a pseudo random sequence by using a pseudo random number generator 420 based on a previously set code key 400. The message generating unit 330 may generate message data by combining the pseudo random sequence generated for coding and a message to which a prefix is added. Here, while not shown in FIG. 4, the message generating unit 330 may embed a bit for forward error correction into message data.

In operation S430, the message embedding unit 340 of the image data processing apparatus 300 divides the original image data 310 into a plurality of color channels. Referring to FIG. 4, the message embedding unit 340 divides the original image data 310 into a red channel 441, a blue channel 442, and a green channel 443.

The message embedding unit 340 obtains a difference component 455 between the red channel 441 and the blue channel 442 in operation S450. Next, the message embedding unit 340 performs FWT on the difference component 455 by using a wavelet converting unit 460 to obtain data 465 in a wavelet domain, the wavelet domain being divided into sub-bands.

Next, the message embedding unit 340 may perform encoding by using an encoder 470 such that the message data generated by using the message generating unit 330 is embedded into at least one of the sub-bands.

In operation S480, the image reconstructing unit 350 detects an edge component of the green channel 443. Next, in operation S485, the image reconstructing unit 350 blurs an edge component of the green channel 443. Here, blurring may be performed by applying a normalized Gaussian Blur.

Also, in operation S475, the image reconstructing unit 350 may perform RFWT on the converted difference component into which message data is embedded into at least one of its sub-bands by using the encoder 470.

Next, in operation S490, the image reconstructing unit 350 may reconstruct the red channel 441 and the blue channel 442 based on original components of the red channel 441 and the blue channel 442, a result of the blurring in operation S485, and a result of performing RFWT in operation S475.

Next, in operation S495, the image reconstructing unit 350 may reconstruct an image based on the red channel 441 and the blue channel 442 that are reconstructed in operation S490 and the green channel 443 to thereby generate reconstructed image data 360.

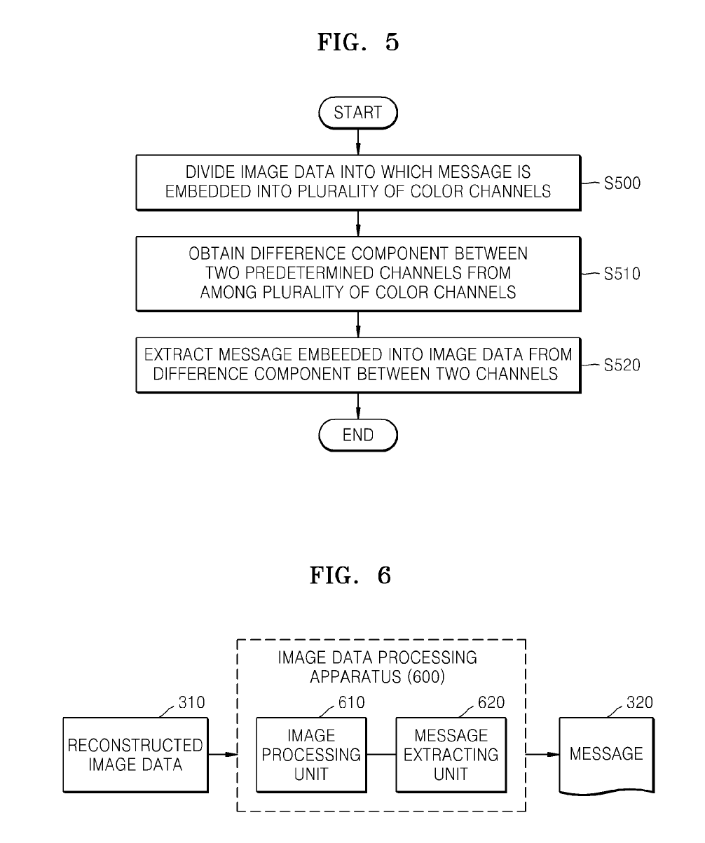

FIG. 5 is a flowchart illustrating an operation of extracting a message from image data according to an exemplary embodiment.

In operation S500, an image data processing apparatus divides image data into which a message is embedded, into a plurality of color channels.

According to an exemplary embodiment, the plurality of color channels may include a red channel, a green channel, and a blue channel.

Next, in operation S510, the image data processing apparatus obtains a difference component between two of the plurality of color channels.

When image data is divided into a red channel, a green channel, and a blue channel in operation S500, a difference component between the red channel and the blue channel may be considered as a difference component between two color channels.

Next, in operation S520, the image data processing apparatus extracts the message embedded into the image data from the difference component of the two color channels.

When image data is divided into a red channel, a green channel, and a blue channel in operation S500, the image data processing apparatus may detect an edge component of the green channel, and may blur the detected edge component. For example, the edge component may be detected by using the Sobel Operator, and a normalized Gaussian Blur may be applied for data normalization.

The image data processing apparatus may obtain message data based on the blurred edge component of the green channel and the difference component between the red channel and the blue channel.

Here, the image data processing apparatus may multiply an inverse of the blurred edge component of the green channel by the difference component of the red channel and the blue channel. Referring to Equation 1, a result of multiplying the inverse of the blurred edge component of the green channel by the difference component between the red channel and the blue channel is expressed in Equation 3 below.

$$\frac{1}{{E}_{blur}} ( {R}_{new} - {B}_{new} ) = \frac{{RB}_{diff}}{{E}_{blur}} + ( {W}_{data} - {RB}_{diff} ) * ( {α}_{red} + {α}_{blue} ) , \qquad [ Equation 3 ]$$

where when a normalized Gaussian Blur is applied to the edge component of the green channel, E_{blur}≈1, and as α_{red}+α_{blue}=1 when referring to Equation 2, a result as according to Equation 4 may be obtained.

$$\frac{1}{{E}_{blur}} ( {R}_{new} - {B}_{new} ) = \frac{{RB}_{diff}}{{E}_{blur}} + ( {W}_{data} - {RB}_{diff} ) * ( {α}_{red} + {α}_{blue} ) \approx {W}_{data} \qquad [ Equation 4 ]$$

Accordingly, a result W_{data} of performing RFWT with respect to the difference component between the red channel and the blue channel into which message data is inserted may be obtained.

Accordingly, the image data processing apparatus may perform FWT on the result W_{data}, which is data into which a message is embedded, to divide the data into sub-bands. The image data processing apparatus may extract a message from the divided sub-bands.

According to an exemplary embodiment, the image data processing apparatus may extract a message by decoding W_{data}, which is the data into which a message is embedded, and may synchronize the extracted message with the image data. The synchronization of the extracted message data may be performed by using a prefix that is added when embedding a message into image data. Also, the image data processing apparatus may decode the message of 4 to 5 bits at the same time when performing synchronization of the extracted message.

Also, according to an exemplary embodiment, although not illustrated in FIG. 5, an error may be detected by using a forward error correction method.

In addition, according to another exemplary embodiment, the image data processing apparatus may generate a pseudo random sequence based on the same code key as a code key used when the message is embedded. The image data processing apparatus may remove the pseudo random sequence included in W_{data} and may extract a message.

FIG. 6 is a schematic structural diagram of an image data processing apparatus 600 for extracting a message from image data according to an exemplary embodiment.

The image data processing apparatus 600 which extracts the message 320 from the reconstructed image data 310 may include an image processing unit 610 that divides the reconstructed image data 310 into a plurality of color channels and obtains a difference component between two predetermined color channels from among the plurality of color channels, and a message extracting unit 620 that extracts the message 320 embedded into the reconstructed image data 310 from the obtained difference component between the two color channels. Although not shown in FIG. 6, the image data processing apparatus 600 may include a processor for device control and calculation.

The image data processing apparatus 600 may extract the message 320 from the reconstructed image data 310.

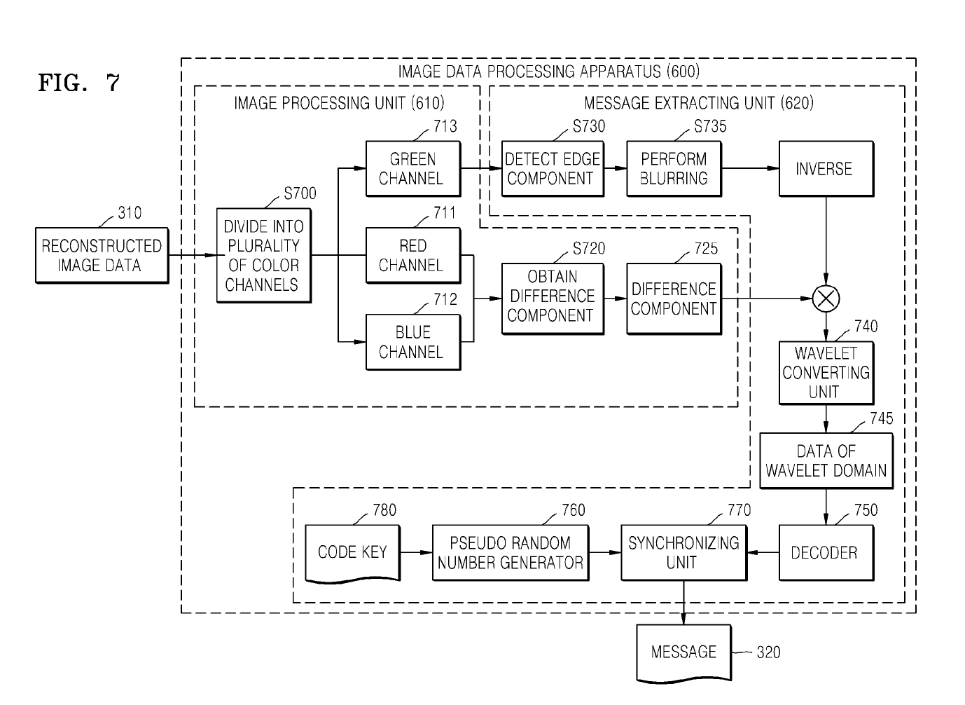

FIG. 7 is a detailed view of an operation of the image data processing apparatus 600 of extracting a message from image data according to an exemplary embodiment.

The image processing unit 610 of the image data processing apparatus 600 divides the image data 310 into a plurality of color channels in operation S700. Referring to FIG. 7, the image processing unit 610 divides the reconstructed image data 310 into a red channel 711, a blue channel 712, and a green channel 713.

Next, in operation S720, the image processing unit 610 obtains a difference component 725 between a red channel 711 and a blue channel 712.

The message extracting unit 620 of the image data processing apparatus 600 detects an edge component of the green channel 713 in operation S730. The message extracting unit 620 blurs the edge component of the green channel 713 in operation S735. Here, the message extracting unit 620 may perform blurring by applying a normalized Gaussian Blur to the edge component of the green channel 713.

Next, the message extracting unit 620 may perform a calculation of multiplying an inverse of the result of the blurring of operation S735 by the difference component 725 to obtain data W_{data} into which the message is embedded.

Next, the message extracting unit 620 may perform FWT on W_{data} by using the wavelet converting unit 740 to obtain data 745 in a wavelet domain, the wavelet domain being divided into sub-bands.

Next, the decoder 750 of the message extracting unit 620 may decode the data 745 in a wavelet domain to obtain message data that is embedded into one of the sub-bands.

Next, a synchronizing unit 770 of the message extracting unit 620 may obtain the message 320 by synchronizing the message data.

Here, although not shown in FIG. 7, the synchronizing unit 770 may correct an error of the message data by forward error correction.

Also, according to an exemplary embodiment, the message extracting unit 620 may generate a pseudo random sequence by using a pseudo random number generator 760 based on a previously set code key 780. The code key 780 may be a key corresponding to the code key 400 that is used when embedding a message into image data. The synchronizing unit 770 may remove information about the pseudo random sequence included in the message data by using the generated pseudo random sequence and extract the message 320.

An exemplary embodiment may also be realized in a form of a recording medium including commands executable by a computer, such as a program module executed by a computer. A computer-readable recording medium may be an arbitrary available medium accessible by a computer, and may be any one of volatile, nonvolatile, separable, and non-separable media. Also, examples of the computer-readable recording medium may include a computer readable storage medium and a communication medium. Examples of the computer readable storage medium include volatile, nonvolatile, separable, and non-separable media realized by an arbitrary method or technology for storing information about a computer-readable command, a data structure, a program module, or other data. The communication medium may include a computer-readable command, a data structure, a program module, other data of a modulated data signal, such as carrier waves, or other transmission mechanisms, and may be an arbitrary information transmission medium.

While exemplary embodiments have been particularly shown and described, it will be understood by those of ordinary skill in the art that various changes in form and details may be made therein without departing from the spirit and scope of the invention as defined by the appended claims. The exemplary embodiments should be considered in a descriptive sense only and not for purposes of limitation. For example, each element described as a single type may be distributed, and similarly, elements described to be distributed may be combined.

The scope of the invention is defined not by the detailed description of the invention but by the appended claims, and all differences within the scope will be construed as being included in the present invention.

What is claimed is:

1. An image data processing method for embedding a message into image data, the method comprising:
generating message data that is to be embedded into the image data;
dividing the image data into a plurality of color channels resulting in a deconstruction of components of the image data, and embedding the message data into a difference component between a first color channel and a second color channel of the plurality of color channels;
reconstructing components of the first color channel and the second color channel by using original components of the two color channels and the difference component between the first color channel and the second color channel into which the message data is embedded; and
reconstructing the image data by using the reconstructed components of the two color channels and an original component of a remaining color channel of the plurality of color channels,
wherein the above steps are performed by using a processor.

2. The image data processing method of claim 1, wherein the plurality of color channels comprise a red channel, a green channel, and a blue channel.

3. The image data processing method of claim 2, wherein the first color channel is the red channel and the second color channel is the blue channel, and wherein the embedding the message data comprises dividing the difference component between the first color channel and the second color channel into a plurality of sub-bands by performing fast wavelet transform (FWT) and embedding the message data into at least one from among the plurality of sub-bands of the divided difference component.

4. The image data processing method of claim 3, wherein the remaining color channel of the plurality of color channels comprises the green channel, and wherein the reconstructing the image data comprises:
detecting an edge component of the remaining color channel;
blurring the detected edge component; and
reconstructing the first color channel and the second color channel based on the difference component between the first color channel and the second color channel, the blurred edge component, a result of reverse fast wavelet transform (RFWT) performed on the image data into which the message data is embedded, and original components of the first color channel and the second color channel.

5. The image data processing method of claim 4, wherein the reconstructing the first color channel and the second color channel comprises reconstructing the first color channel and the second color channel by performing a calculation of one from among adding and subtracting a result of multiplication of a result of performing RFWT on the image data into which the message data is embedded, the blurred edge component of the remaining color channel, and intensities of signals to be embedded into the first color channel and the second color channel, to/from the original components of the first color channel and the second color channel.

6. The image data processing method of claim 1, wherein the generating the message data comprises adding a prefix to the message data,
wherein the embedding the message data comprises encoding the message data such that the message data to which the prefix is added is embedded into the difference component between the two color channels.

7. An image data processing method of extracting a message data that is embedded into encoded image data, the method comprising:
dividing the image data into a plurality of color channels and obtaining a difference component between a first color channel and a second color channel of the plurality of color channels; and
extracting the message data embedded into the image data from the difference component between the first color channel and the second color channel,
wherein the above steps are performed by using a processor.

8. The image data processing method of claim 7, wherein the plurality of color channels comprise a red channel, a green channel, and a blue channel.

9. The image data processing method of claim 8, wherein the first color channel is the red channel and the second color channel is the blue channel,
wherein the extracting the message data comprises:
detecting an edge component of a remaining color channel of the plurality of color channels;
blurring the detected edge component; and
obtaining the message data into which the message is embedded based on the difference component between the first channel and the second channel and the blurred edge component.

10. The image data processing method of claim 9, wherein the extracting the message comprises obtaining the message data in which the message is embedded by performing a calculation of multiplying the difference component between the first channel and the second channel by an inverse of the blurred edge component.

11. The image data processing method of claim 9, wherein the extracting of the message comprises:
dividing the data in which the message is embedded into sub-bands by performing fast wavelet transform (FWT); and
extracting the message from the sub-bands.

12. The image data processing method of claim 7, wherein the extracting the message comprises:
obtaining the encoded message data in which the message is embedded from the difference component between the first color channel and the second color channel;
extracting the message by decoding the data into which the message is embedded; and
synchronizing the extracted message with the image data.

13. An image data processing apparatus comprising:
a message generator configured to generate message data that is to be embedded into image data;
a message embedder configured to divide the image data into a plurality of color channels resulting in a deconstruction of components of the image data and embed the message data into a difference component between a first color channel and a second color channel of the plurality of color channels; and
an image reconstructor configured to reconstruct components of the first color channel and the second color channel by using original components of the two channels and the difference component between the two channels into which the message data is embedded, and reconstructing the image data by using reconstructed components of the two color channels and an original component of a remaining color channel of the plurality of color channels.

14. The image data processing apparatus of claim 13, wherein the plurality of color channels comprise a red channel, a green channel, and a blue channel.

15. The image data processing apparatus of claim 14, wherein the first color channel is the red channel and the second color channel is the blue channel, and the message embedder comprises:
a wavelet converter configured to perform fast wavelet transform (FWT) on the difference component between the first color channel and the second color channel, to divide the difference component into a plurality of sub-bands; and
an encoder configured to embed the message data into at least one from among the plurality of sub-bands of the divided difference component.

16. The image data processing apparatus of claim 14, wherein the remaining color channel of the plurality of color channels comprises the green channel, and wherein the image reconstructor detects an edge component of the remaining color channel, blurs the detected edge component, and performs reverse fast wavelet transform (RFWT) on the data into which the message data is embedded,
wherein the first color channel and the second color channel are reconstructed based on the difference component between the first color channel and the second color channel, the edge component of the remaining color channel to which the blurring is performed, a result of RFWT on the image data into which the message data is embedded, and original components of the first color channel and the second color channel.

17. The image data processing apparatus of claim 16, wherein the image reconstructor reconstructs the first color channel and the second color channel by performing a calculation of one from among adding and subtracting a result of multiplication of a result of performing RFWT on the image data into which the message data is embedded, the blurred edge component of the remaining color channel, and intensities of signals to be embedded into the first color channel and the second color channel, to/from the original components of the first color channel and the second color channel.

18. The image data processing apparatus of claim 13, wherein the message generator adds a prefix to the message data, and
the message embedder comprises an encoder that encodes the message such that the message data to which the prefix is added is embedded into a difference component between the two color channels.

19. An image data processing apparatus comprising:
an image processor configured to divide encoded image data into a plurality of color channels and obtain a difference component between a first color channel and a second color channel from among the plurality of color channels; and
a message extractor configured to extract a message data that is embedded into the image data from the difference component between the first color channel and the second color channel.

20. The image data processing apparatus of claim 19, wherein the plurality of color channels comprise a red channel, a green channel, and a blue channel.

21. The image data processing apparatus of claim 20, wherein the first color channel is the red channel and the second color channel is the blue channel,
wherein the message extractor detects an edge component of remaining channels of the plurality of color channels and blurs the detected edge component, and the message data into which a message is embedded is obtained based on the difference component between the first color channel and the second color channel and the blurred edge component.

22. The image data processing apparatus of claim 21, wherein the message extractor obtains the message data into which the message is embedded, by performing a calculation of dividing the difference component between the first color channel and the second color channel by the blurred edge component.

23. The image data processing apparatus of claim 21, wherein the message extractor comprises:
a wavelet converter configured to perform fast wavelet transform (FWT) on the data into which the message is embedded, to thereby divide the data into a plurality of sub-bands; and
a decoder configured to extract the message from the plurality of sub-bands.

24. The image data processing apparatus of claim 19, wherein the message extractor obtains the encoded message data into which the message data is embedded, from the difference component between the first color channel and the second color channel,
wherein the message extractor comprises:
a decoder configured to extract the message by decoding the encoded message data into which the message is embedded; and
a synchronizer configured to synchronize the extracted message with the image data.

25. A non-transitory computer-readable storage medium having embodied thereon a program, which when executed by a computer, performs the method of claim 1.

26. The image data processing method of claim 1, wherein the generating the message data comprises combining a random sequence and the message to which a prefix is added.

27. The image data processing apparatus of claim 13, wherein the message generator generates the message data by combining a random sequence and the message to which a prefix is added.
